(19) United States
(12) Patent Application Publication
(10) Pub. No.: US 2015/0339828 A1
(43) Pub. Date: Nov. 26, 2015

(54) SEGMENTATION OF A FOREGROUND OBJECT IN A 3D SCENE

(71) Applicant: THOMSON LICENSING, Issy de Moulineaux (FR)

(72) Inventors: Abdelaziz DJELOUAH, Cesson Sevigne (FR); Patrick PEREZ, Rennes (FR); Francois LE CLERC, L'Hermitage (FR); Jean-Sebastien FRANCO, Saint Ismier (FR); Edmond BOYER, Saint Ismier (FR)

(21) Appl. No.: 14/404,578

(22) PCT Filed: May 30, 2013
(86) PCT No.: PCT/EP2013/061146

§ 371 Date: Nov. 28, 2014

(30) Foreign Application Priority Data
May 31, 2012 (EP) 12305603.8
Nov. 15, 2012 (EP) 12306425.5
Apr. 11, 2013 (EP) 13305474.2

(51) Int. Cl. G06T 7/00

(52) U.S. Cl. CPC G06T 7/0087; G06T 7/0081; G06T 2207/10012; G06T 2207/10024; G06T 2207/20144; G06T 2207/30196

(57) ABSTRACT

A method and a module for segmenting a foreground region from a background region in a 3D scene captured by n capturing devices. A reduced number of 3D samples are selected in the scene. These 3D samples are projected in each captured image. Foreground probability and background probabilities are computed for each selected 3D sample based on color models and the projection of these samples in the images These probabilities are used to update the color models. These probabilities are then re-computed based on the updated color models. These steps are reiterated until the color models or the foreground and background probabilities of the selected 3D samples converge. A final segmentation is computed using foreground color models and foreground and background probabilities.

### TECHNICAL FIELD

The present invention relates to a method and a module for segmenting a foreground region from a background region in a three-dimensional scene.

### PRIOR ART

Segmenting foreground objects in images is an important topic in computer vision with numerous applications in scene analysis and reconstruction. The problem has been extensively addressed in the monocular case, and in the multi-ocular case with controlled environments, typically, scenes filmed against a uniformly green or blue background. Multi-view segmentation with general environments is however still a largely unsolved problem, despite the growing interest for multi-view systems.

Segmenting a foreground object in a 3D scene using a multi-view acquisition setup results in the estimation of binary segmentation maps in each view, wherein a first segmentation label is assigned to pixels corresponding to the foreground object and a second segmentation label is assigned to pixels corresponding to the background. The term silhouette will be used hereafter to refer to the regions of these segmentation maps labeled as foreground. A first category of known approaches treat multi-view silhouette extraction and 3D reconstruction simultaneously. For this category, two sub-categories of methods can be distinguished. A first sub-category addresses primarily the 3D segmentation problem, treating silhouettes as noisy inputs from which to extract the best representation. This approach attempts to construct a consistent segmentation of the foreground object in 3D space from estimations of the silhouettes of this object in each view. Solutions are found with well established convergence properties, e.g, using graph cuts, probabilistic frameworks, or convex minimization. A solution illustrating this approach is described in the document “Fast joint estimation of silhouettes and dense 3D geometry from multiple images”, K. Kolev, T. Brox, D. Cremers, IEEE PAMI 2011. A second sub-category treats the joint 2D-3D segmentation problem by updating color models for foreground and background in each view. This usually translates in a costly 3-stage pipeline, iteratively alternating between color models updating, image segmentations, and construction of a 3D segmentation of the object, for instance as the 3D visual hull of the silhouettes computed in each view. All resort to a form of conservative and costly binary decision of visual hull occupancy or 2D segmentation, e.g., using graph cuts in the volume. Such an approach is for example described in the document “Automatic 3D object segmentation in multiple views using volumetric graph-cuts” N. D. F Campbell, G. Vogiatzis, C. Hernandez, R. Cipolla, Image Vision Comput, 2010. The convergence properties of these pipelines are difficult to establish and the need for dense 3D reconstruction has a high computational cost.

A second category of known approaches focus on the problem of extracting the silhouettes in each view rather than on segmenting the foreground object in 3D space. The problem of multi-view foreground segmentation in itself has only recently been addressed as a stand-alone topic, and few approaches exist. An initial work discussed in “Silhouette extraction from multiple images of an unknown background”, G. Zeng, L. Quan, ACCV 2004, has identified the problem as finding a set of image segmentations consistent with a visual hull, and proposes an algorithm based on geometric elimination of superpixel regions, initialized to an over-segmentation of the silhouette. This deterministic solution proves of limited robustness to inconsistently classified regions and still relies on an explicit 3D model. Some more recent approaches try to address the problem primarily in 2D using more robust, implicit visual hull representations. For example, the document “Silhouette segmentation in multiple views”, W. Lee, W. Woo, E. Boyer, IEEE PAMI 2010, gives a probabilistic model of silhouette contributions to other images of pixels over their viewing lines, and alternatively update all views. The proposed pipelines are still quite complex and fall just short of computing the 3D reconstruction itself. Convergence properties of these methods are hard to establish.

### SUMMARY OF THE INVENTION

The object of the present invention is to alleviate all or part of these defects.

More specifically, an object of the present invention is to propose a multi-view silhouette segmentation avoiding a dense 3D reconstruction at each iteration of the process in order to reduce the computation needs.

The invention proposes a new approach avoiding these defects using a 2D/3D compromise, avoiding complete dense representations, while encoding the exact specificities of the multi-view segmentation problem.

More specifically, the invention concerns a method for segmenting a foreground region from a background region in a three-dimensional scene, said scene being captured by n capturing devices disposed at several points of view and generating n images or views of the scene, with n≧2, the method comprising the successive following steps:

a) determining a volume in 3D space bounding said foreground region;

b) defining, for each image, a first color model associated to the foreground region within the projection of the bounding volume in the image, and a second color model associated to the background region within the projection of the bounding volume in the image;

c) selecting a plurality of 3D samples inside the bounding volume according to a predetermined law;

d) projecting the selected 3D samples in each image;

e) computing, in each image, the probabilities that the colors associated to the projection of the selected 3D samples belong to the first and second color models;

f) computing, for each one of the selected 3D samples, a probability, called foreground probability, that it belongs to the foreground region in the n images and, for each image, a probability, called background probability, that it belongs to the background region of said image according to the result of step e);

g) updating said first and second color models in each image according to the foreground and background probabilities associated to the 3D samples computed in step f);

h) reiterating steps e) to g) until the first and second color models of the foreground and background probabilities of the selected 3D samples meet a predetermined convergence criterion, the 3D samples belonging to the foreground region being the 3D samples having a foreground probability higher than each one of the background probabilities.

Step b) can be done after step a) or step c).

According to this method, a reduced number of 3D samples is selected in order to reduce the computation needs. In addition, the color models associated to the foreground region and the background region in the bounding volume for each image are defined in the 2D domains defined by the projection of the bounding volume in each view, reducing the complexity of the method in comparison to approaches requiring the reconstruction of a 3D model of the foreground object.

In a preferred embodiment, the method further comprises a step i), after step h), for refining the foreground/background segmentation in each image according to a predefined optimization criterion based on at least the foreground probabilities of the projections of the selected 3D samples in said image and the matching of the colors of the pixels in said image with the first color model determined for said image in step b) and updated at step g).

Advantageously, said predefined optimization criterion is also based on a constraint favoring the assignment of identical segmentation results, foreground or background, to neighboring pixels.

According to an embodiment, the convergence criterion of step h) is met when the first and second colors models in each image do not vary during at least m consecutive iterations of the method, m being greater than or equal to 2.

In another embodiment, the convergence criterion of step h) is met when the selected 3D samples having a foreground label do not vary during at least m consecutive iterations of the method, m being greater than or equal to 2.

According to an embodiment, the bounding volume is determined by intersecting the visual fields associated to said capturing devices. In a variant, said bounding volume is determined by user inputs.

According to an embodiment, the first and second color models for each image are color histograms in Lab or HSV color space.

According to an embodiment, the selected 3D samples are obtained by applying one of the following samplings over the bounding volume: a regular 3D sampling according to predetermined grid, a random sampling or an adaptive sampling. In the latter case, the adaptive sampling is for example a coarse to fine sampling. In this case, a reduced number of 3D samples is first selected and then, according to the results of step f), other 3D samples are selected in a region of the bounding volume wherein the number of foreground 3D samples is high.

According to an embodiment, in step b) or g), the second color model of the background region in each image is constrained to be consistent with a color model built from the points outside of the projection of the bounding volume in the image.

The invention relates also to a module for segmenting a foreground region from a background region in a three-dimensional scene, said scene being captured by n capturing devices disposed at several points of view and generating n images or views of the scene, with n≧2, the module comprising:
storage means for storing said n images of the scene, program instructions and data necessary for the operation of the foreground region segmentation module,
computer means for
   determining a volume in 3D space bounding said foreground region;
   computing, for each image, initial estimates of a first color model associated to the foreground region within the projection of the bounding volume in the image, and a second color model associated to the background region within the projection of the bounding volume in the image;
   selecting a plurality of 3D samples inside the bounding volume according to a predetermined law;
   projecting the selected 3D samples in each image;
   computing, in each image, the color probabilities that the colors associated to the projection of the selected 3D samples belong to the first and second color models,
   computing, for each one of the selected 3D samples, a probability, called foreground probability, that it belongs to the foreground region in the n images and, for each image, a probability, called background probability, that it belongs to the background region of said image according to the color probabilities,
   updating said first and second color models in each image according to the foreground and background probabilities associated to the 3D samples;
   reiterating said computing and updating operations until the first and second color models of the foreground and background probabilities of the selected 3D samples meet a predetermined convergence criterion; and
   refining the foreground/background segmentation in each view.

### BRIEF DESCRIPTION OF THE DRAWINGS

FIG. 1 represents a 3D scene having a foreground region and a background region, said scene being captured by two cameras;

FIG. 2 is a flow chart illustrating the steps of the inventive method;

FIG. 3 is a chart illustrating the dependency graph between the variables of the method of FIG. 2;

FIG. 4 is a chart illustrating the dependency graph between variables used in the step E9 of the flow chart of FIG. 2;

FIG. 5 and FIG. 6 are images illustrating the results of the inventive segmentation method, compared to those of a monocular GrabCut segmentation; and

FIG. 7 is a diagram representing schematically a hardware module implementing the steps of FIG. 2 according to a particular implementation of the invention;

FIG. 8 represents a graph connecting 3D samples of the 3D scene of FIG. 1 with pixels or regions of pixels within the images of the scene and terminal nodes labeled foreground and background, according to a particular implementation of the invention;

FIG. 9 represents the graph connecting pixels (or regions of pixels) of a first image of the scene at a time t with pixels (or regions of pixels) of a second image of the same scene at a time t+1, according to a particular implementation of the invention.

### DETAILED DESCRIPTION OF PREFERRED EMBODIMENTS

In the present description, we consider a set of n calibrated images of a 3D scene captured at an identical time instant by a plurality of capturing devices disposed at several points of view. Each 3D sample s of the scene can be defined by a color tuple (Iₛ¹, . . . , Iₛⁿ) where Iₛ^{j} is the color representation of the projection of the 3D sample s in the image j.

Color models are defined for the foreground object and the background region in each image. If a 3D sample is part of the foreground object, it means that all corresponding tuple colors should simultaneously be predicted from the foreground color model in their respective images. Conversely, if the sample is not part of the foreground object, it means that there exists one image where the corresponding color of the sample should be predicted from the background color model in this image, the color representations of the 3D sample in all other views being indifferent in that case. Therefore, a classification label kₛ can be assigned to each 3D sample s, with values in the label space K={f,b₁,b₂, . . . , bₙ} where f is the foreground label, and bᵢ is a label meaning that the color representation of the 3D sample in view i excludes it from the foreground.

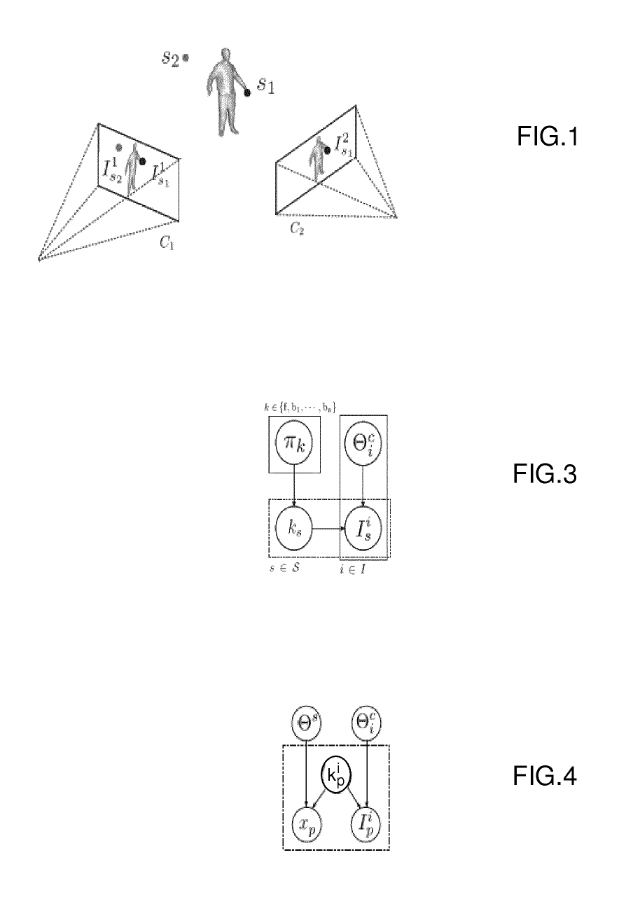

FIG. 1 illustrates such a multi-view consistency at 3D sample level. Sample s₁ is considered as a foreground sample since all its projections Iₛ₁¹ and Iₛ₁² are in the foreground regions of the images 1 and 2 generated by the cameras C₁ and C₂. The foreground label f can thus be assigned to sample s₁. Conversely, the sample s₂ is considered as a background sample since the color representation of its projection in image C₁ marks it as a background pixel, thus excluding it from the foreground. The background label b₁ can thus be assigned to sample s₂.

According to an important feature of the invention, only sparse 3D samples of the scene are selected for the segmentation and these selected 3D samples are used to accumulate and propagate foreground and background labels between views.

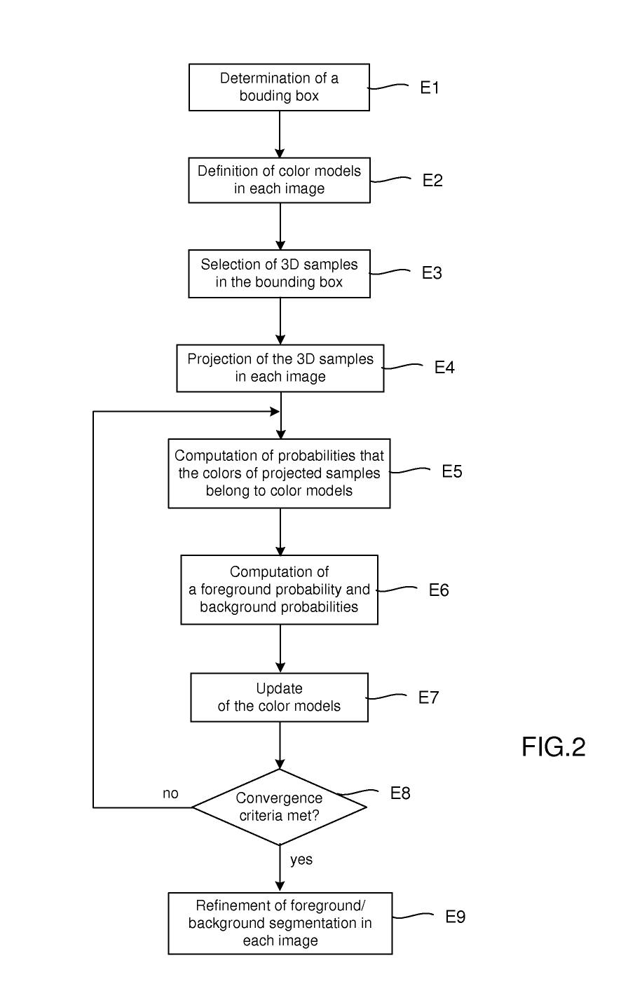

The method of the invention is described in more detail hereinafter. With reference to FIG. 2, the method of the invention comprises the following successive steps:
step E1: determining a volume bounding said foreground region;
step E2: defining, for each view, a first color model associated to the foreground region in the projection of the bounding volume in the view, and a second color model associated to the background region in the projection of the bounding volume in the view;
step E3: selecting a plurality of 3D samples of the bounding volume according to a predetermined law;
step E4: projecting the selected 3D samples in each image;
step E5: computing, in each image, the probabilities that the colors associated to the projection of the selected 3D samples belong to the first and second color models;
step E6: computing, for each one of the selected 3D samples, a probability, called foreground probability, that it belongs to the foreground region in the n images and, for each image, a probability, called background probability, that it belongs to the background region of said image according to the result of step E5;
step E7: updating said first and second color models in each image according to the foreground and background probabilities associated to the 3D samples;
step E8: reiterating steps E5 to E7 until the first and second color models or the foreground and background probabilities of the selected 3D samples meet a predetermined convergence criterion, the 3D samples belonging to the foreground region being the 3D samples having a foreground label;
step E9: refining the foreground/background segmentations in each view on the basis of 3D sample foreground/background probabilities and color models.

Step E1—Determination of a Volume Bounding the Foreground Region

This bounding volume is a part or the totality of the common visual field of the cameras. It is for example determined by intersecting the visual fields associated to the cameras capturing the 3D scene. This step is possible since the relative positions of the cameras and their focal distances are known. In fact, the foreground region is considered as belonging to the n images of the scene captured by the n cameras. Thus, this bounding volume defines a volume in space wherein the foreground object is assumed to be present.

Step E2—Definition of Color Models for Foreground and Background Regions in Each Image

A color model for the foreground object and a color model for the background region are defined in each image i. These models characterize the color distribution in each image i. The color models are for example color histograms in HSV or Lab color space expressing the complementary nature of foreground and background distributions in each image. The number of occurrences in each bin of the background histograms and foreground histograms, noted respectively Hᵢ and H̅ᵢ for a region Rᵢ in the image i, sum to the number of bin occurrences of the histogram Hᵢ^{int} of the whole region Rᵢ (Hᵢ^{int}=Hᵢ+ H̅ᵢ). In the description to be followed, the region Rᵢ designates the projection of the bounding volume in the image i.

Both the foreground and background color models are fully parameterized by Hᵢ, since Hᵢ^{int} is known for each image i. A global color model noted θ^{c} such as θ^{c}={Hᵢ}_{iε{1, . . . , n}} is sufficient to define the foreground region and the background region in a scene, since the histograms { H̅ᵢ}_{iε{1, . . . , n}} can be computed from {Hᵢ^{int}}_{iε{1, . . . , n}} as the complementary histograms to the {Hᵢ}_{iε{1, . . . , n}}.

In addition, the complementary of region Rᵢ, noted Rᵢ^{c}, in the image is initially identified as a background region, yielding a per-image histogram Hᵢ^{ext}. The regions Rᵢ and Rᵢ^{c} can be obtained automatically: typically Rᵢ can be computed as the projection in view i of the bounding volume determined in step E1, and Rᵢ^{c} is the complementary of Rᵢ in image i. According to an embodiment of this invention, the pixels of this outer region Rᵢ^{c} are used to constrain Hᵢ during initialization and convergence.

In addition, a set of mixing coefficients πₖ, with kεK, is advantageously defined, each coefficient πₖ representing the proportion of samples having the state k in a group G of selected samples of the scene (the πₖ sum to 1).

In this step, the color model can be initialized without making any assumption regarding the foreground/background proportion in image histograms. This means that the background proportion in each bin of the image histogram Hᵢ is set to 0.5. Thus, at the beginning of the process, the pixels of the region Rᵢ are split equally in the histogram Hᵢ and the histogram H̅ᵢ. Hᵢ and H̅ᵢ are substantially identical at the end of this initialization step.

Advantageously, the color model θ^{c} is constrained by the fact that there exists a similarity between the background pixels in the region Rᵢ and the pixels in the outer region Rᵢ^{c} that is a known background region. This similarity can be used to improve the color model θ^{c}. In that case, the computation of model θ^{c} from the color representations of the 3D samples projections in each view (step E4 to be followed) is constrained to comply with a predefined prior probability defined by:

$$p ( {θ}^{c} ) {Π}_{i} {Π}_{p ∈ {R}_{i}^{c}} {H}_{i} ( {I}_{p}^{i} ) \qquad ( 1 )$$

The color model θ^{c} is thus optimized by ensuring the background color models are consistent with the colors observed in the known background regions Rᵢ^{c}.

Step E3—Selection of a Plurality of 3D Samples of the Bounding Volume According to a Predetermined Law

A plurality of 3D samples is selected in the bounding volume. The population of the selected 3D samples is supposed to well represent the variety of color co-occurences in the bounding volume. The selected samples can be obtained by applying a regular 3D sampling on the 3D samples within the bounding volume. S designates the set of selected 3D samples and s designates a selected 3D sample.

In a variant, the selected 3D samples are obtained by applying a random sampling. In another variant, the selected 3D samples are obtained by applying an adaptive sampling or a coarse to fine sampling. In the latter case, a reduced number of 3D samples are selected in a first step and, at each iteration of the method, additional 3D samples are selected in the area of the bounding volume wherein the number of foreground 3D samples is high.

Step E4—Projection of the Selected 3D Samples in Each Image

According to the invention, the selected 3D samples are projected in each captured image i. Iₛⁱ designates the color representation of the projection of the sample s in the image i and I={iₛⁱ}_{sεS,iε{1, . . . , n}}. So the n-tuple) (Iₛ¹, . . . , Iₛⁿ) is associated to each sample s of the set S. In each image i, the projections of these 3D samples are included in the region Rᵢ, which is the projection of the bounding volume in the image i.

Step E5—Computation of the Probabilities that the Colors Associated to the Projection of the Selected 3D Samples in Each Image Belong to Each of the Two Color Models of Step E2

According to the invention, each sample's color tuple Iₛⁱ is predicted as illustrated by the dependency graph of FIG. 3, according to its classification label kₛ with priors πₖ and to the global color models θᵢ^{c}.

Thus, for kₛεK, I={Iₛⁱ}_{sεS,iε{1 . . . n}}, θ^{c}={θᵢ^{c}}_{iε{1, . . . , n}} and π={πₖ}_{kεK}, the joint probability of observations I, latent variables K, and model parameters θ^{c} and π factorizes as follows:

$$p ( {θ}^{c} , I , π , K ) = p ( {θ}^{c} ) p ( π ) {\prod }_{s ∈ S} p ( {k}_{s} , {I}_{s}^{1} , … , {I}_{s}^{n} \vert {θ}^{c} , π ) \qquad ( 2 )$$

where p(π) is uniform and will be ignored in the following computations.

From FIG. 3, for a given sample s, we have

$$p ( {k}_{s} , {I}_{s}^{1} , … , {I}_{s}^{n} \vert {θ}^{c} , π ) = [ {Π}_{i}^{n} p ( {I}_{s}^{i} \vert {θ}_{i}^{c} , {k}_{s} ) ] p ( {k}_{s} \vert π ) \qquad ( 3 )$$

If a sample is classified as foreground sample, then all colors from the corresponding tuple should be drawn from the foreground color model. But, if a sample is classified as background sample for the image i (3D sample label is bᵢ) then the i-th color of the tuple should be predicted from the background color model in image i, and the color models in all other views are indifferent, which amounts to drawing these color models in other views from the color model of the entire projection Rᵢ of the bounding volume:

$$p ( {I}_{s}^{i} \vert {θ}_{i}^{c} , {k}_{s} ) = \{ \begin{matrix}{H}_{i} ( {I}_{s}^{i} ) & if {k}_{s} = {b}_{i} \\ {\overline{H}}_{i} ( {I}_{s}^{i} ) & if {k}_{s} = f \\ {H}_{i}^{int} ( {I}_{s}^{i} ) & otherwise ( {k}_{s} = {b}_{j} with j \neq i )\end{matrix} \qquad ( 4 )$$

Thus, the color representations Iₛⁱ of each 3D sample s in each view i are matched to the color models determined in step E2, and the probabilities of these color representations, conditioned to the color model θ^{c} and 3D sample labels kₛ, are set according to equation (4). This is really where the per view samples classification is performed. A sample satisfying the background color model for a particular image i does not need to be checked against other color models in other images. It just needs to be likely under the color model H^{int} of region Rᵢ.

The term p(kₛ|π) represents a mixture proportion prior

p(kₛ=π)=πₖ_{ₛ}. (5)

Equations (4) and (5) allow to compute the right-hand term of equation (3) as a function of the color model probabilities determined in step e) and of the latent variables πₖ_{ₛ}. The resulting expression can be, in turn, substituted in the right-hand term of equation (2), to obtain the a posteriori probability of the observations I and latent variables K, given the priors on the model parameters θ^{c} and π.

Following the classical Maximum A Posteriori (MAP) statistical estimation method known from prior of art, the estimation of these model parameters is then performed by maximizing the a posteriori probability defined by equation (2) with respect to the values of the model parameters θ^{c} and π. This maximization is the object of the steps E6 and E7, to be followed.

Step E6—Determination, for Each 3D Sample, of a Foreground Probability and n Background Probabilities

For this step, an Expectation Maximization (EM) algorithm is used. EM is an iterative process, which alternates between the posterior over classification variables given the current parameter estimate Φ^{g} (E-step), and estimating the new set of parameters Φ maximizing the expected log-posterior under the previously evaluated probabilities (M-step).

In the present case, Φ={θ^{c},π}. The Expectation and Maximization steps are built on the following Q-functional:

$$\begin{matrix} Q ( Φ , {Φ}^{g} ) = {\sum }_{K} log ( p ( I , K , Φ ) ) p ( K \vert I , {Φ}^{g} ) & ( 6 ) \\ Q ( Φ , {Φ}^{g} ) = {\sum }_{K} log ( {Π}_{s} p ( {k}_{s} , {I}_{s}^{1} , … , {I}_{s}^{n} \vert Φ ) ) {Π}_{{s}^{′}} p \begin{matrix}(\end{matrix} {k}_{{s}^{′}} \vert {I}_{{s}^{′}}^{1} … , {I}_{{s}^{′}}^{n} {Φ}^{g} ) {\sum }_{i} {\sum }_{p ∈ {R}_{i}^{c}} log ( {H}_{i} ( {I}_{p}^{i} ) ) & ( 7 ) \\ Simplifying this equation gives the following equation \\ Q ( Φ , {Φ}^{g} ) = {\sum }_{s} {\sum }_{k ∈ K} log ( p ( {k}_{s} = k , {I}_{s}^{1} , … , {I}_{s}^{n} \vert Φ ) ) p ( {k}_{s} = k \vert {I}_{{s}^{′}}^{1} … , {I}_{{s}^{′}}^{n} {Φ}^{g} ) + {\sum }_{i} {\sum }_{p ∈ {R}_{i}^{c}} log ( {H}_{i} ( {I}_{p}^{i} ) ) & ( 8 )\end{matrix}$$

and the new set of parameters is Φ=argmax_{Φ}Q(Φ,Φ^{g}).

Step E6 corresponds to the E-step, or Expectation step, of the EM algorithm. During this step, the probability that the classification label kₛ is equal to k, with kεK, is computed for each 3D sample s by the following expression:

$$∀ k ∈ K , p ( {k}_{s} = k \vert {I}_{s}^{1} , … , {I}_{s}^{n} , {Φ}^{g} ) = \frac{{Π}_{k}^{g} [ {Π}_{i}^{n} p ( {I}_{s}^{i} I {θ}_{i}^{g , c} , {k}_{s} = k ) ]}{{\sum }_{z} {Π}_{k}^{g} [ {Π}_{i}^{n} p ( {I}_{s}^{i} I {θ}_{i}^{g , c} , {k}_{s} = k ) ]} \qquad ( 9 )$$

At the end of this step, n+1 probabilities are computed for each 3D sample. p(kₛ=k|Iₛ¹, . . . Iₛⁿ,Φ^{g}) is noted pₛ^{k} in the following description.

Step E7—Update of the Color Models in Each Image According to the Probabilities Computed at Step E6

Step E7 corresponds to the M-step, or Maximization step, of the EM algorithm. In this step, we find the new set of parameter φ that maximizes the Q function defined by equation (6). We can write this function as the sum of independent terms:

$$Q ( Φ , {Φ}^{g} ) = {\sum }_{s , k} {p}_{s}^{k} log {π}_{k} + {\sum }_{i} [ {\sum }_{s , k} {p}_{s}^{k} log ( p ( {I}_{s}^{i} \vert {θ}_{c}^{i} , {k}_{s} = k ) ) + {\sum }_{p ∈ {R}_{i}^{c}} log ( {H}_{i} ( {I}_{p}^{i} ) ) ] \qquad ( 10 )$$

Each term can be maximized independently. For πₖ:

$${π}_{k} = \frac{1}{N} {\sum }_{s} {p}_{s}^{k} \qquad ( 11 )$$

wherein N is the number of selected samples.

Maximizing the image related terms is equivalent to maximizing the expression Aᵢ(Hᵢ) such as

$${A}_{i} ( {H}_{i} ) = {\sum }_{s} [ {p}_{s}^{{b}_{i}} log ( {H}_{i} ( {I}_{s}^{i} ) ) + {p}_{s}^{f} log ( \overline{{H}_{i}} ( {I}_{s}^{i} ) ) ] + {\sum }_{p ∈ {R}_{i}^{c}} log ( {H}_{i} ( {I}_{p}^{i} ) ) \qquad ( 12 )$$

where we ignore the bⱼ labels (j≠i) because they are related to the constant model Hᵢ^{int}. Let b be a particular bin in the color space. We note by H_{b} the number of occurrences in b for the histogram H. Hᵢ^{ext} is the histogram of the outer region Rᵢ^{c}. We can then write Aᵢ(Hᵢ) as a sum of independent terms, each one related to a different bin of the color space:

$${A}_{i} ( {H}_{i} ) = {\sum }_{b} {\sum }_{{s ∈ S}_{{I}_{s}^{i} ∈ b}} [ {p}_{s}^{{b}_{i}} log ( \frac{{H}_{i , b}}{{\vert {H}_{i} \vert}_{L 1}} ) + {p}_{s}^{f} log ( \frac{{H}_{i , b}^{int} - {H}_{i , b}}{{\vert {H}_{i}^{int} - {H}_{i} \vert}_{L 1}} ) ] + {\sum }_{{p ∈ {R}_{i}^{c}}_{{I}_{p}^{i} ∈ b}} log ( \frac{{H}_{i , b}^{ext}}{{\vert {H}_{i}^{ext} \vert}_{L 1}} ) \qquad ( 13 )$$

wherein L1 is the known norm.

It can be shown that optimizing this quantity is equivalent to updating bin values as follows

$${H}_{i , b} = \frac{{\sum }_{s ∈ S , {I}_{s}^{i} ∈ b} {p}_{s}^{{b}_{i}} + {H}_{i , b}^{ext}}{{\sum }_{s ∈ S , {I}_{s}^{i} ∈ b} ( {p}_{s}^{{b}_{i}} + {p}_{s}^{f} ) + {H}_{i , b}^{ext}} + {H}_{i , b}^{int} \qquad ( 14 )$$

In this step, the bins of the color model θᵢ^{c}={Hᵢ} in the image i are updated as indicated by equation (14). Since Hᵢ^{int} is known for each image i, the bins of the histogram H̅ᵢ can also be computed.

According to a particular embodiment, the updating of the color models is performed by using a graph to be cut in two parts according to the well known graph cut method.

The graph-cut method provides an optimization tool in computer vision and in particular provides an exact solution to the problem of computing an optimal binary Foreground/Background image segmentation, given known priors on the labels of each pixel and a smoothness constraint that encourages consistent labeling of neighbouring pixels with similar appearance. The binary segmentation problem is modeled as a graph where each pixel of each image is represented by a node (p, q), and two extra terminal nodes s (source) and t (sink) are added to represent the labels to be assigned to the pixels (i.e. foreground and background). Each edge in the graph is assigned a non-negative weight that models its capacity. The larger the weight of an edge, the larger the likelihood that its endpoint nodes share the same label. Edges connecting two non-terminal nodes are called n-links, while edges connecting a terminal node to a non-terminal node are called t-links.

An s/t cut (or simply a cut) is a partitioning of the nodes in the graph into two disjoint subsets S and T such that the source s is in S and the sink t is in T. Alternatively stated, an s-t cut severs exactly one of the t-links of each non-terminal node of the graph. This cut implicitly defines an assignment of the labels defined by the source and the sink to each pixel of the image, according to whether the node associated to the pixel remains linked to S or to T after the cut.

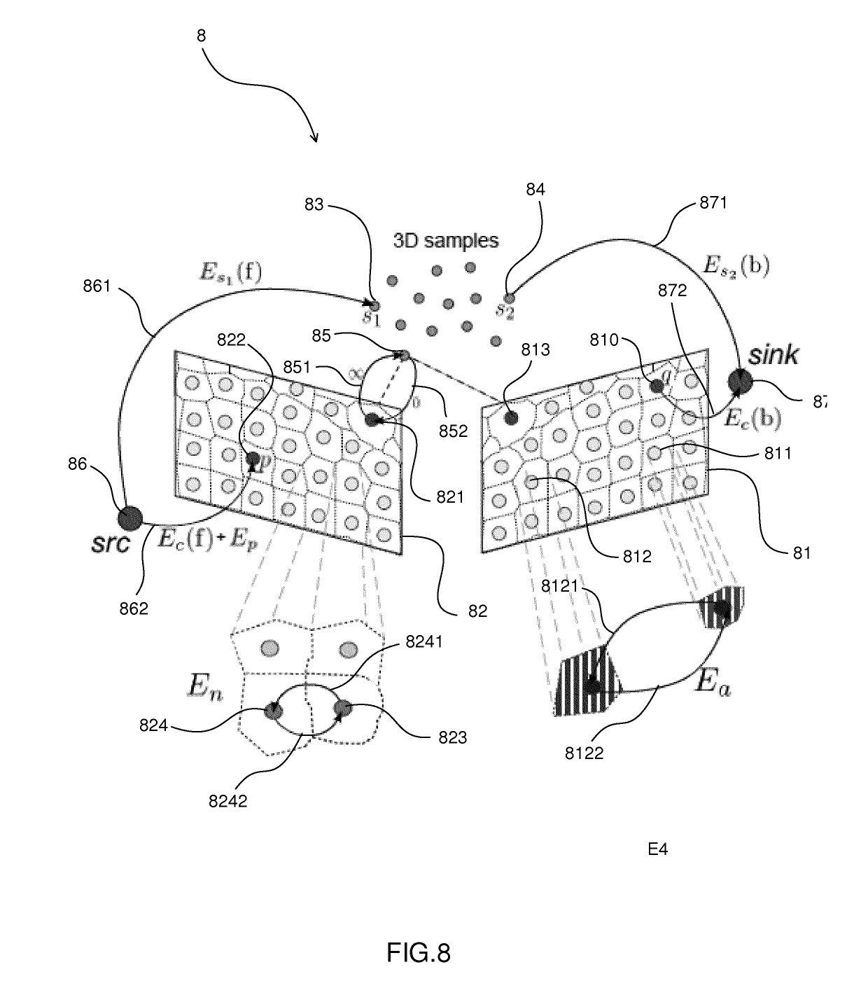

A graph according to this particular and non limitative embodiment is illustrated on FIG. 8. The graph 8 comprises two terminal nodes 86 and 87, also called source (src) and sink, one of them being associated with the label foreground (for example the terminal node sink 87) and the other one being associated with the label background (for example the terminal node source 86). The graph 8 also comprises several sets of first nodes, i.e. a set of first nodes for each image of the n images, a first node being associated with a pixel of an image. In an advantageous way, there are as many first nodes as pixels in the images. According to a variant, each node represents a region of neighboring pixels in an image. A first image 81 comprises a plurality of first nodes 810, 811, 812, 813 and a second image 82 comprises a plurality of first nodes 821, 822, 823 and 824. The graph 8 also comprises a set of second nodes 83, 84, 85, each second node corresponding to a 3D sample of the set of 3D samples selected at step E3. The graph 8 may thus be seen as a multi-layer graph with a layer comprising the first nodes, a layer comprising the second nodes and two other layers each comprising one of the two terminal nodes 86, 87.

The first nodes are advantageously each connected to each one of the two terminal nodes. The first node q 810 is advantageously connected to the terminal node sink 87 (representing the foreground label) via a first edge 872 and connected to the second terminal node src 86 (representing the background label) with another first edge (not illustrated on FIG. 8). In a same way, the first node 822 associated with a pixel of the image 82 is connected to the terminal node src 86 via a first edge 862 and to the terminal node sink 87 via another first edge (not illustrated on FIG. 8). The first edges are advantageously weighted with first weighting coefficients associated with them. The first weighting coefficients are representative of the probability that a pixel or a region of neighboring pixels associated with a first node belongs to the foreground or the background. The higher the probability that the first node associated with the first edge is labeled background, the lower the value of the first weighting coefficient on the edge linking said first node with the terminal node labeled foreground. Similarly, the higher the probability that the first node associated with the first edge is labeled foreground, the lower the value of the first weighting coefficient on the edge linking said first node with the terminal node labeled background. The first weighting coefficient is for example equal to Ec(f)+Ep if the first edge connects a first node to the terminal node source 86 (in the example wherein the terminal node source is labeled as background), wherein Ec(f) is representative of the inverse of the probability that the color associated with the first node belongs to the first color model, i.e. the color model associated with the foreground region resulting from steps E2 and the application of step E7 in the previous iterations; and Ep is representative of the inverse of the maximal foreground probability of all 3D samples projecting onto the pixel or the region of neighboring pixels associated with the first node. The first weighting coefficient is for example equal to Ec(b) if the first edge connects a first node to the terminal node sink 87 (in the example wherein the terminal node sink represents the foreground label), wherein Ec(b) is representative of the inverse of the probability that the color associated with the first node belongs to the second color model, i.e. the color model associated with the background region resulting from steps E2 and the application of step E7 in the previous iterations. Ec and Ep will be defined with more details thereafter.

The second nodes are advantageously each connected to each one of the two terminal nodes. The second node S2 84 is advantageously connected to the terminal node sink 87 (representing the foreground label) via a second edge 871 and connected to the second terminal node src 86 (representing the background label) with another second edge (not illustrated on FIG. 8). In a same way, the second node S1 83 is connected to the terminal node src 86 via a second edge 861 and to the terminal node sink 87 via another second edge (not illustrated on FIG. 8). The second edges are advantageously weighted with second weighting coefficients associated with them. The second weighting coefficients are representative of the foreground probability or of the background probability associated with the 3D samples associated with the second nodes 83 and 84. The second weighting coefficient associated with the second edge 861 is equal to Es1(f), Es1(f) being representative of the inverse of the foreground probability associated with the 3D sample S1 83 computed at step E6. The second weighting coefficient associated with the second edge 871 is equal to Es2(f), Es2(f) being representative of the inverse of the complement to one of the foreground probability associated with the 3D sample S2 84 computed at step E6. Es1(f) and Es2(f) will be defined with more details thereafter.

The first nodes are advantageously connected via third edges with each other in a given image, for example first nodes 810, 811, 812, 813 of the image 81 are connected with each other via third edges and the first nodes 821, 822, 823 and 824 of the image 82 are connected with each other via third edges. First nodes 811 and 812 of the image 81 are for example connected via two third edges 8121 and 8122 and first nodes 823 and 824 of the image 82 are for example connected via two third edges 8241 and 8242. The third edges are advantageously weighted with third weighting coefficients. One of the two third edges connecting two first nodes is for example weighted with a third weighting coefficient representative of the dissimilarity Ea between the two pixels or regions of neighboring pixels associated with the two first nodes connected by this third edge (the similarity corresponding for example to the similarity of the colors and/or of the textures associated with the connected first nodes). The other one of the two third edges connecting the two first nodes is for example weighted with a third weighting coefficient representative of the inverse of the gradient intensity En at the frontier between the two pixels or regions of neighboring pixels associated with the first nodes connected via this weighted third edge. Ea and En will be defined with more details thereafter.

The second nodes are advantageously connected with some of the first nodes of the n images via fourth edges. The first node(s) 821, 813 connected to a second node 85 correspond to the first node(s) associated to pixels or regions of neighboring pixels onto which the 3D sample associated with the second node 85 projects in the images 81 and 82. A second node is connected with a first node with two fourth edges, one in each direction, each fourth edge being weighted with a fourth weighting coefficient, a fourth weighting coefficient being able to take two values, the value 0 and the value “infinity”, the fourth weighting coefficient Ej ensuring consistency between the labeling of a 3D sample and the labeling of the pixels or regions of neighboring pixels of the n images onto which the 3D sample projects. Ej will be defined with more details thereafter.

According to a variant, the pixels of each image of the n images are grouped so as to form superpixels. A superpixel corresponds to a connected region of an image, larger than a pixel, that is rendered in a consistent color, brightness and/or texture. Alternatively stated, a superpixel groups one or more neighboring pixels that share similar colors, brightness and/or texture. According to this variant, the first nodes of the graph 8 are associated with the superpixels of the n images such as 81 and 82. Using superpixels improves computational efficiency as far fewer nodes in the graph need to be processed to obtain the segmentation. Moreover, superpixels embed more information than pixels as they also contain texture information. This information can advantageously be used to propagate a given label between neighboring superpixels that share similar texture.

Given the above-described graph, the update of the color models in each of the n images I={I¹, . . . , Iⁿ} of the considered scene derives from a graph cut segmentation that assigns a foreground or a background label to, firstly, a set of pixels or superpixels Pᵢ partitioning image Iⁱ, for each such image, and, secondly, a set of 3D points denoted as “3D samples”, sampled in the common visibility volume of all the cameras. A global energy or cost function is defined on the graph as the weighted sum of t-links and n-links weights. This cost function assigns a value to every possible assignment of labels in the set {foreground, background} to each of the non-terminal nodes in the graph. As known from the state of the art and proved in the paper entitled “Interactive Graph Cuts for Optimal Boundary & Region Segmentation of Objects in N-D Images”, by Y. Boykov and M. P. Jolly, published in the 2001 International Conference on Computer Vision, the minimum s-t cut on the graph minimizes the global cost function over the set of partitions of the graph into foreground and background nodes, and thereby yields the optimal foreground/background segmentation.

Going into more detail, given the superpixel decomposition and 3D samples, we wish the choice of the edge weights on the graph to reward a given labeling of all superpixels according to the following aspects:

Individual appearance: the appearance of a pixel or superpixel should comply with image-wide foreground or background color models, depending on its label.

Appearance continuity: two neighboring pixels or superpixels are more likely to have the same labels if the intensity discontinuity along their shared border is weak.
Appearance similarity: two pixels or superpixels with similar color/texture are more likely to be part of the same object and thus, more likely to have the same label.
Multi-view coherence: 3D samples are considered object consistent if they project to foreground regions with high likelihood.
Projection constraint: assuming sufficient 3D sampling of the scene, a pixel or a superpixel is foreground if it sees at least one object consistent sample in the scene. Conversely, a pixel or a superpixel is background if it sees no object consistent 3D sample.

The edge weight contributions associated to these aspects are preferably defined as follows. For each image I of a set of images I={I¹, . . . , Iⁿ}, we define Pi to be the set of its superpixels. Cosegmenting in all the views consists in finding for every pixel or superpixel p of Pi its label xₚ with xₚ belonging to {f,b}, the foreground and background labels. We denote S the set of 3D samples selected and used to model dependencies between the views.

### Intra-View Appearance Terms

The classic combination of unary data terms with spatial smoothness terms on pixels or superpixels is used, to which non-local appearance similarity terms on pixels or superpixel pairs is added to enable broader propagation of information and finer appearance description.

Individual appearance term: Ec is denoted as being the unary data-term related to each pixel or superpixel appearance. Appearance is characterized by the sum of pixel-wise log-probabilities of being predicted by an image-wide foreground or background appearance distribution. Ec may be calculated via the following equation:

$${E}_{c} ( {x}_{p} ) = \{ \begin{matrix}{\sum }_{r ∈ {ℛ}_{p}} - log {H}_{i}^{B} ( {I}_{r}^{i} ) & if {x}_{p} = b , \\ {\sum }_{r ∈ {ℛ}_{p}} - log {H}_{i}^{F} ( {I}_{r}^{i} ) & if {x}_{p} = f\end{matrix} ,$$

with Rp the set of pixels contained in superpixel p and Iⁱᵣ the color of pixel r in view i that contains p. View-wide color histograms H^{F}ᵢ and H^{B}ᵢ are used for foreground and background appearances, but other appearance models may be used.

Appearance continuity term: this binary term, denoted En, discourages the assignment of different labels to neighboring pixels or superpixels whose common boundary exhibits weak image gradients. Let Nⁱₙ define the set of adjacent pixels or superpixel pairs in image i and, for (p;q) belonging to Nⁱₙ, let Bᵣ(p;q) be the set of pixel pairs straddling superpixels p and q. To this goal, proposed En integrates the gradient response over the border for each (p;q) belonging to Nⁱₙ, as follows:

$${E}_{n} ( {x}_{p} , {x}_{q} ) = \{ \begin{matrix}\frac{1}{1 - {\sum }_{r ∈ {ℬ}_{r} ( p , q )} log ‖ ∇ {I}_{r}^{i} ‖} & if {x}_{p} \neq {x}_{q} , \\ 0 & otherwise\end{matrix} .$$

Appearance similarity term: for the purpose of favoring consistent labels and efficient propagation among pixels or superpixels of similar appearance during a cut, a second non-local binary term Ea(xₚ; x_{q}) is introduced. To this goal, a richer appearance vector Ap collecting color and texture statistics over Br(p; q) is associated with each pixel or superpixel p. The mean color and overall gradient magnitude response is collected for three scales over the pixel or superpixel. A set Nⁱₐ of similar pixels or superpixels is built by retrieving for each pixel or superpixel its K-nearest neighbors with respect to Euclidean distance d on variance-normalized appearance vectors Ap and defined as follows:

$${E}_{a} ( {x}_{p} , {x}_{q} ) = \{ \begin{matrix}\frac{1}{1 + d ( {\hat{A}}_{p} , {\hat{A}}_{q} )} & if {x}_{p} \neq {x}_{q} , \\ 0 & otherwise\end{matrix} .$$

### Inter-View Geometric Consistency Terms

To propagate geometric consistency, every pixel may be connected to every other view's epipolar line pixels it depends on to evaluate consistency. To avoid the combinatorial graph complexity, sparse 3D samples are instead used and connected to the pixels or the superpixels they project on to propagate information. As geometric consistency of samples may change during iteration because of evolving segmentations, an “abjectness” probability measuring consistency with current segmentations is evaluated before each iteration, and used to reweigh the propagation strength of the sample, using a per-sample unary term, as described hereafter.

Sample objectness term: let P^{f}ₛ be the probability that a 3D sample s belonging to S is labeled foreground, as computed in step E6. A unary term Es and a label xₛ (xₛ standing for x_{S1} or x_{S2} according to samples S1 83 and S2 84) are associated with the sample s, allowing the cut algorithm the flexibility of deciding on the fly whether to include s in the propagation based on all MRF terms:

$${E}_{s} ( {x}_{s} ) = \{ \begin{matrix}- log ( 1 - {P}_{s}^{f} ) & if {x}_{s} = b , \\ - log {P}_{s}^{f} & if {x}_{s} = f\end{matrix} .$$

Sample-pixel junction term: to ensure projection consistency, each 3D sample s is connected to the pixels or superpixels p it projects onto, which defines a neighborhood Ns. A binary term Ej is defined as follows:

$${E}_{j} ( {x}_{s} , {x}_{p} ) = \{ \begin{matrix}∞ & if {x}_{s} = f and {x}_{p} = b , \\ 0 & otherwise\end{matrix} .$$

The key property of this simple energy is that no cut of the corresponding graph 8 may assign simultaneously to background a pixel or a superpixel p and to foreground a 3D sample s that projects on p. Thus it enforces the following desirable projection consistency properties:
Silhouette-consistent sample labeling: all 3D samples s projecting on a background-labeled pixel or superpixel p will be cut to background
Segmentations are inclusive of projected foreground sample set: all pixels or superpixels p seeing a foreground sample s will be cut to foreground; in other words, if a 3D sample s is labeled as foreground, then pixels or superpixels at its projection positions cannot be labeled as background: this corresponds to an impossible cut.

Sample projection term: the purpose of this term is to discourage foreground labeling of a pixel or superpixel p when no sample was labeled foreground in the 3D region Vₚ seen by the pixel or superpixel, and conversely to encourage foreground pixel or superpixel labeling as soon as a sample s in Vₚ is foreground. Let P(xₚ|Vₚ) be the maximum probability of all foreground samples seen by p, as computed between two cut iterations. The sample projection term is defined as:

Eₚ(xₚ)=−log P(xₚ|Vₚ).

Let X be the conjunction of all possible sample and pixels/superpixel labels. The global energy or cost function on the graph is preferably defined as the sum of two groups of terms. The intra-view group results in a sum over all images i, and the inter-view group has its own multi-view binary and unary terms:

$$E ( X ) = {λ}_{3} {\sum }_{s ∈ S} {E}_{s} ( {x}_{s} ) + {\sum }_{( s , p ) ∈ {𝒩}_{s}} {E}_{j} ( {x}_{s} , {x}_{p} ) + {\sum }_{i = 1}^{n} {\sum }_{p ∈ {𝒫}_{i}} {E}_{p} ( {x}_{p} ) + {\sum }_{i = 1}^{n} ( {\sum }_{p ∈ {𝒫}_{i}} {E}_{c} ( {x}_{p} ) + {λ}_{1} {\sum }_{( p , q ) ∈ {𝒩}_{n}^{i}} {E}_{n} ( {x}_{p} , {x}_{q} ) + {λ}_{2} {\sum }_{( p , q ) ∈ {𝒩}_{a}^{i}} {E}_{a} ( {x}_{p} , {x}_{q} ) ) , \qquad ( 7 )$$

where λ₁, λ₂, λ₃ are relative weighing constant parameters. Advantageously, λ₁ is set to 2.0, λ₂ is set to 4.0 and λ₃ is set to 0.05. Finding a cosegmentation for the set of images, given a set of histograms H^{B}ᵢ and H^{F}ᵢ, probabilities P^{f}ₛ consists in finding the labeling X minimizing this energy. This is performed using an s-t min cut algorithm.

The application f the s-t min cut algorithm assigns a foreground or a background label to each superpixel node in the graph, and thereby to each of the pixels making up the superpixels in each view. The foreground and background color histograms that define the color model for each view are eventually recomputed from these pixel label assignments, which completes step E7.

According to another particular embodiment of the invention, the above-described graph cut scheme for updating color models in step E7 is extended to the segmentation of multi-view image sequences, by propagating segmentation labels among temporally neighbouring images representing the same viewpoint.

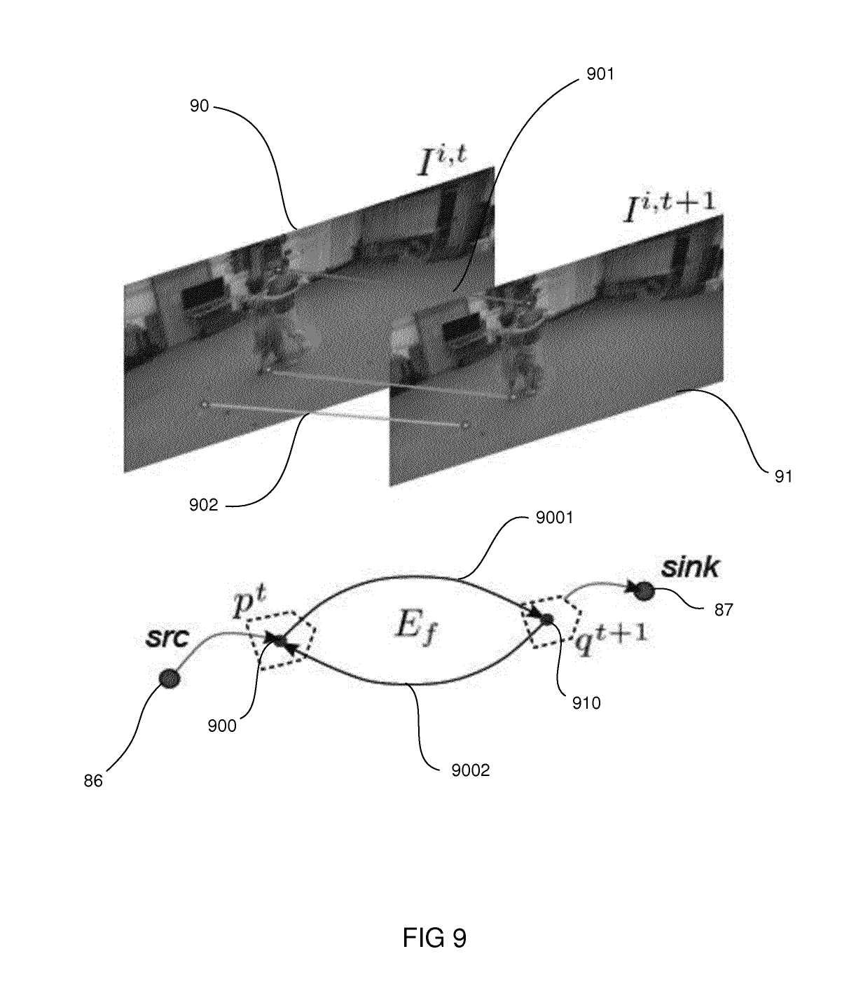

To this end, as shown on FIG. 9, links 901, 902 are established between the superpixels of a given image Iᵢ^{t} 90 representing viewpoint i at time instant t, and the superpixels of image Iᵢ^{t+1} 91 representing viewpoint i at the next time instant t+1. Advantageously, the links 901, 902 can be established, following methods known from the state of art, by computing an optical flow between Iᵢ^{t} and Iᵢ^{t+1}, and/or detecting SIFT points of interest in Iᵢ^{t} and Iᵢ^{t+1}, and establishing matches between the said points of interest. When optical flow is used, links are established from a superpixel sᵢ^{t} of image Iᵢ^{t} with a predefined number P_{S} of superpixels of image Iᵢ^{t+1} on which the largest number of pixels in sᵢ^{t} project, following the displacement vectors computed by the optical flow. When SIFT matches are used, links are established from a superpixel sᵢ^{t} of image Iᵢ^{t} with a predefined number P_{S} of superpixels of image Iᵢ^{t+1} on which the largest numbers of matches occur. P_{S} is advantageously set to 2.

These temporal links 901, 902 define additional edges 9001, 9002 on the graph, as shown on FIG. 9. The weight associated to an edge linking superpixel node xₚ^{t} 900 at time t and superpixel node xₚ^{t+1} 910 at time t+1 is set to the following time consistency energy value:

$${E}_{f} ( {x}_{{p}^{t}} , {x}_{{q}^{t + 1}} ) = \{ \begin{matrix}{θ}_{f} exp ( \frac{- {d ( {A}_{{p}^{t}} , {A}_{{q}^{t + 1}} )}^{2}}{2 < d ( {A}_{{p}^{t}} , {A}_{{p}^{t + 1}} > 2} ) & if {x}_{{p}^{t}} \neq {x}_{{q}^{t + 1}} , \\ 0 & otherwise\end{matrix} .$$

In this expression, Aₚ^{t} represents the appearance descriptor for superpixel xₚ^{t} at time t, A_{q}^{t+1} represents the appearance descriptor for superpixel x_{q}^{t+1} at time t+1, d(A₁, A₂) is a distance between two superpixel descriptors, and θ_{f} is a term that depends on the nature of the considered link. In the case of SIFT-based links, θ_{f} is advantageously chosen to be inversely proportional to a measure of the distance between the two SIFT descriptors set in correspondence by the link. In the case of optical-flow based links, θ_{f} is advantageously set to 1.0.

The appearance Aₚ^{t} of superpixel p at time t can be defined as any vector of texture and color features computed over the superpixel. Advantageously, texture attributes can be obtained by computing the average magnitude response of a high-pass filter applied to the superpixel, at different scales, a color attribute can be computed as the components of the mean color over the superpixel, and the distance between two superpixel descriptors can be chosen to be the Euclidean distance on variance-normalized appearance vectors.

The min s-t cut algorithm that computes the optimal assignment of either a foreground or a background label to each node of the graph is performed over a sliding window of T temporal instants, on each of which the same set of n viewpoint images Iᵢ^{t} and the set of 3D samples S^{t} is available. T is advantageously set to 5. At each temporal position of this sliding window, a single color model is computed on the basis of the label assignments of the superpixels of the n views for the T considered time instants.

Step E8: Reiteration of Steps E5 to E7 Until a Predetermined Convergence Criterion is Met.

The steps E5 to E7 are iterated until the color models or the foreground and background probabilities of the selected 3D samples meet a predetermined convergence criterion.

In a first embodiment, the convergence criterion is met when the color models θᵢ^{c}={Hᵢ}, with iε{1 . . . n}, do not vary during at least m consecutive iterations of the method, m being greater than 2.

In another embodiment, the convergence criterion is met when the selected 3D samples having a foreground label do not vary during at least m consecutive iterations of the method, m being greater than 2.

At the end of this step, a part of the selected 3D samples has a foreground label. These 3D samples are considered as belonging to the foreground region of the scene. The remaining selected 3D samples are considered as belonging to the background region of the scene.

Step E9—Final Segmentation

The EM scheme described previously will converge to an estimate of the color models for each image and a classification probability table for each 3D sample. Reprojecting the 3D samples in each view, and assigning the 3D sample label (foreground or background) to the resulting pixels, would only yield a sparse image segmentation in each view. This is why we use the obtained estimates to build a final dense 2D segmentation, combining results of sample classifications and color models. This is required only once after convergence. Segmentation amounts then to find for each pixel p of the i^{th} view (image i), the correct labeling kₚⁱ (foreground or background) according to the model illustrated by FIG. 4.

We propose to find the correct per pixel labeling of image i by minimizing the following discrete energy using the graph cut algorithm known from the state of art:

$$E = {\sum }_{p} {E}_{d} ( {k}_{p}^{i} \vert {θ}^{s} , {θ}_{i}^{c} , {x}_{p} , {I}_{p}^{i} ) + {\sum }_{\{ p , q \} ∈ {N}^{i}} λ {E}_{s} ( {I}_{p}^{i} , {I}_{q}^{i} ) \qquad ( 15 )$$

The data related term, E_{d}, at pixel p depends first, on how likely its color is under color models obtained for image i. It also depends on how its spatial position xₚ relates to projections in the image of the set of softly classified 3D samples (θ^{s} stands for the 3D samples' positions and associated probabilities {pₛ^{k}}_{s,k}):

E_{d}(kₚⁱ|θ^{s},θ_{c}ⁱ,xₚ,Iₚⁱ)=−log(p(xₚ|θ^{s},kₚⁱ)p(Iₚⁱ,kₚⁱ)) (16)
p(xₚ|θ^{s},kₚⁱ) is proportional to a Gaussian around projections in the images of 3D samples labeled foreground with a high probability. This allows to smoothly project inferred foreground information.
p(Iᵢ^{p}|θᵢ^{c},kₚⁱ) is based on foreground or background histograms previously obtained:

$$p ( {I}_{i}^{p} \vert {θ}_{i}^{c} , {k}_{p}^{i} ) = \{ \begin{matrix}{H}_{i} ( {I}_{p}^{i} ) & if {k}_{p}^{i} = background \\ \overline{{H}_{i}} ( {I}_{p}^{i} ) & if {k}_{p}^{i} = foreground\end{matrix} \qquad ( 17 )$$

Eₛ is a smoothness term over the set of neighbour pixels (Nᵢ) that favors the assignment of identical segmentation labels, foreground or background, to neighboring pixels. It can be any energy that favors consistent labeling in homogeneous regions. In the present case, this energy is a simple inverse distance between neighbor pixels.

Experimental Results

Experiments were done on synthetic and real calibrated multi-view datasets. We used 3D HSV color histograms, with 64×64×16 bins. In the initialization step, we are not making any assumption regarding the foreground/background proportion in image histograms. This means that background proportion in each bin of the image histogram is set to 0.5. To initialize the bounding volume, we use the common field of view but the method is also entirely compatible with user inputs as is shown in our experiments. Experiments were performed on a 2.0 GHz dual core personal computer with 2 GB RAM, with a sequential C++ implementation. Computation time is typically few seconds per iteration, and convergence was reached in less than 10 iterations for all the tests.

The 3D samples can be drawn from any relevant 3D point in space. In practice, we draw samples from the common visibility domain of all cameras. For our initial experiments, we used a regular 3D sampling, and obtained very fast convergence for a small number of samples (50³).

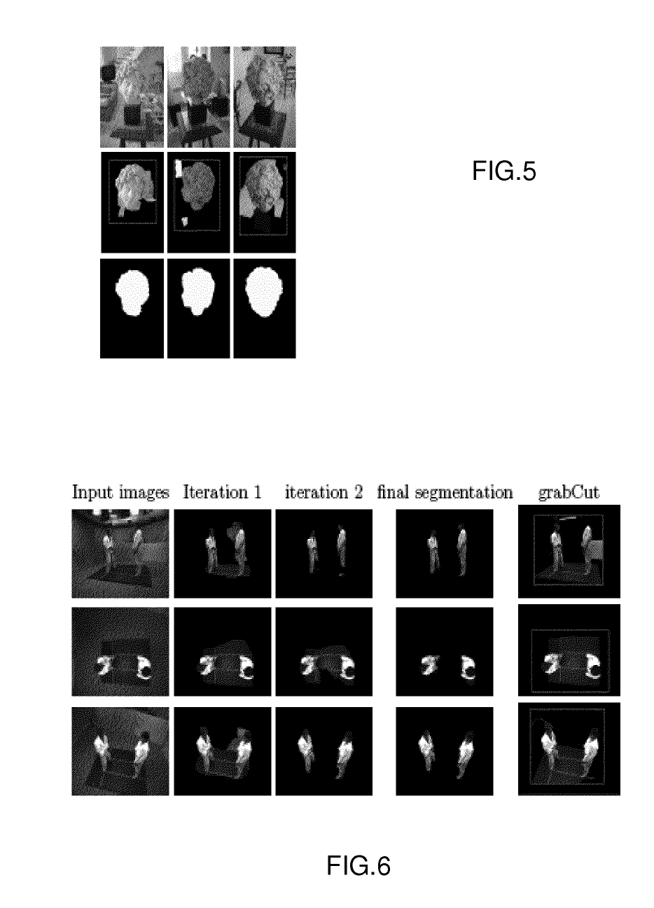

We compare the segmentation results of the present method to a standard GrabCut segmentation to show the advantage of using multiview approach. The different results (FIG. 5 and FIG. 6) illustrate typical GrabCut failure. Indeed, in a monocular approach, it is hard to eliminate background colors that were not present outside the bounding volume. In contrast, the present method benefits from the information of the other views and provides a correct segmentation. In FIG. 5, the first row shows the input images of a bust, the second row shows the results with grabCut and the third row shows the final segmentation with the present method. In FIG. 6, the first column shows the input images (“Arts martiaux”), the second column shows the segmentation results at the end of a first iteration, the third column shows the segmentation results at the end of a second iteration, the fourth column shows the final segmentation results of the present method and the fifth column shows the GrabCut segmentation results.

The present method offers important advantages over the state of art methods. No hard decision is taken at any time. This means that samples once labeled as background with high probability, can be relabeled foreground during the convergence of the algorithm if this is consistent in all the views, illustrating the increased stability with respect to existing approaches. Convergence is reached in few seconds which is far better than several minutes in the state of the art methods.

Although the invention has been described in connection to different particular embodiments, it is to be understood that it is in no way limited thereto and that it includes all the technical equivalents of the means described as well as their combinations should these fall within the scope of the claimed invention.

In the case wherein an adaptive sampling is used to select 3D samples in the bounding box, the steps E3 and E4 are introduced in the iteration loop. Additional 3D samples are selected in the area of the bounding box wherein the foreground samples are present.

Another variant of the approach is to use one color histogram to describe foreground regions. This histogram is shared by all the views. Foreground and background histograms are no longer complementary. Nevertheless, the method for segmenting the foreground object from the background described above can still be applied, provided a few modifications are brought to the equations of steps E5 and E7.

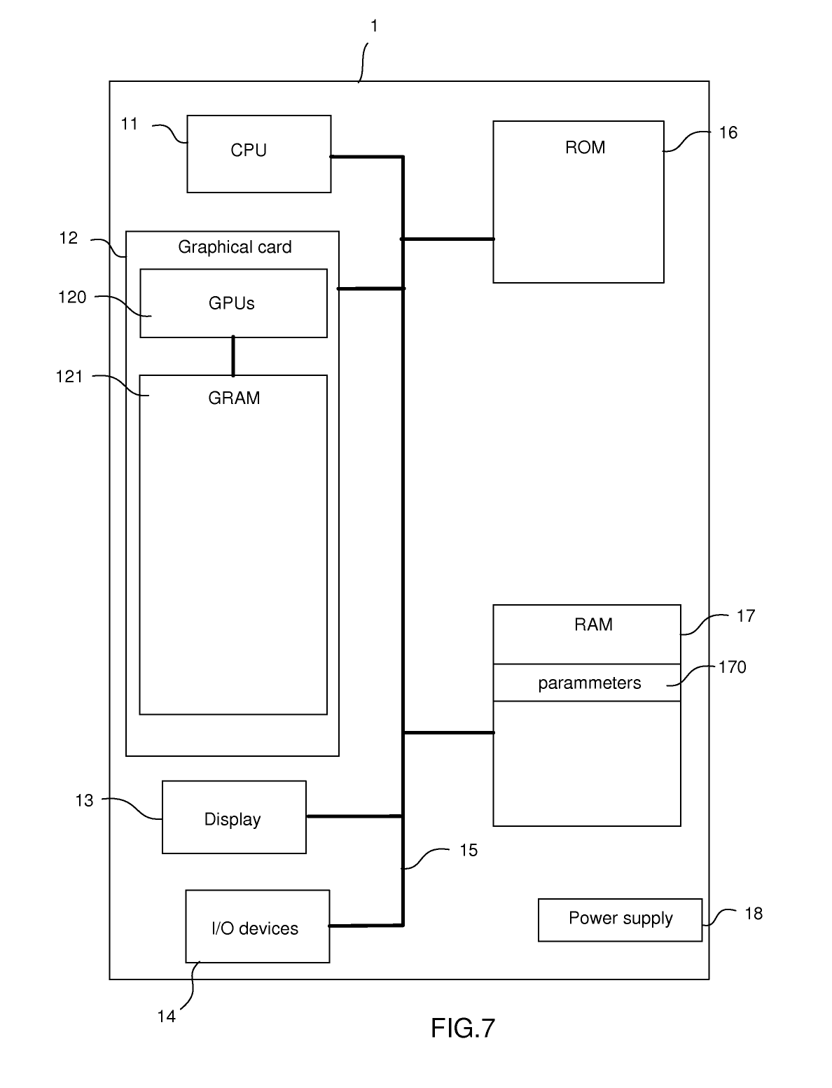

FIG. 7 diagrammatically shows a hardware embodiment of a device 1 adapted for the segmentation of a foreground object in 3D scene, according to a particular and non-restrictive embodiment of the invention. The device 1 is for example to a personal computer PC or a laptop.

The device 1 comprises the following elements, connected to each other by a bus 15 of addresses and data that also transports a clock signal:
a microprocessor 11 (or CPU),
a graphics card 12 comprising:
   one or several Graphical Processor Units (or GPUs) 120,
   a Graphical Random Access Memory (GRAM) 121,
a non-volatile memory of ROM (Read Only Memory) type 16,
a Random Access Memory or RAM 17,
one or several I/O (Input/Output) devices 14 such as for example a keyboard, a mouse, a webcam, and
a power source 18.

The device 1 also comprises a display device 13 of display screen type directly connected to the graphics card 12 to display notably the display of synthesized images calculated and composed in the graphics card. According to a variant, a display device is external to the device 1 and is connected to the device 1 by a cable transmitting the display signals. The device 1, for example the graphics card 12, comprises a means for transmission or connection (not shown in FIG. 7) adapted to transmit a display signal to an external display means such as for example an LCD or plasma screen or a video-projector.

When switched on, the microprocessor 11 loads and executes the instructions of the program contained in the RAM 17.

The random access memory 17 notably comprises:
the operating program of the microprocessor 11 responsible for initializing the device 1,
the program instructions and data needed for the implementation of the foreground object segmentation algorithm.

Advantageously, the program instructions loaded in the RAM 17 and executed by the microprocessor 11 implement the initialization steps E1 to E4 of the algorithm (shown on FIG. 7), while the computationally intensive steps E5 to E9 are executed on the GPUs 120. To this purpose, the n images or views of the scene, the locations of the projections of the samples in each image computed in step E3, and the initial values of the color models computed in step E2 as well as of the priors πₖ on the samples labels, are copied from the RAM 17 into the graphical RAM 121. Further, once the parameters 170 representative of the environment are loaded into the RAM 17, the GPU instructions for steps E5 to E9 of the algorithm, in the form of microprograms or “shaders” written for instance in the OpenCL or CUDA shader programming languages, are loaded into the GRAM 121. When the program code reaches step E5 of the algorithm, dedicated CPU instructions transfer the execution of subsequent steps E5 to E9 to said shaders and retrieves the results of the corresponding computations over the bus 15.

1. A method of segmenting a foreground region from a background region in a three-dimensional scene, wherein said scene is captured by n capturing devices disposed at several points of view and generating n images of the scene, with n≧2, the method comprising:
a) determining a volume bounding said foreground region; then
b) defining a first color model associated to the foreground region in the bounding volume and a second color model associated to the background region in the bounding volume for each image; then
c) selecting a plurality of 3D samples of the bounding volume according to a predetermined law; then
d) projecting the selected 3D samples in each image; then
e) computing, in each image, the probabilities that the colors associated to the projections of the selected 3D samples belong to the first and second color models; then
f) computing, for each one of the selected 3D samples, a probability, called foreground probability, that it belongs to the foreground region in the n images and, for each image, a probability, called background probability, that it belongs to the background region of said image according to the result of said computing of the probabilities; then
g) updating said first and second color models in each image according to the foreground and background probabilities associated to the 3D samples; and then
h) reiterating e) to g) until the first and second color models or the foreground and background probabilities of the selected 3D samples meet a predetermined convergence criterion, the 3D samples belonging to the foreground region being the 3D samples having a foreground probability higher than each one of the background probabilities.

2. The method according to claim 1, wherein said updating of said first and second color models comprises:
g1) constructing a graph comprising two terminal nodes, a foreground label being associated with one of the two terminal nodes and a background label being associated with the other one of the two terminal nodes, first nodes each associated with a pixel or a superpixel of said n images, second nodes each associated with a 3D sample of the selected 3D samples, the first and second nodes being connected to each of the two terminal nodes via first and second weighted edges, the first nodes being connected with each other via third weighted edges and the second nodes being connected to the first nodes via fourth weighted edges,
g2) cutting said graph according to the min s-t cut method in a first and in a second part, the first part of the graph comprising one of the two terminal nodes, at least a part of the first nodes and a at least a part of the second nodes and the second part of the graph comprising the other one of the two terminal nodes and the first and second nodes not comprised in the first part.

3. The method according to claim 2, wherein each first node is connected to each terminal node via a first weighted edge, a first weighting coefficient being associated with the first weighted edge, the first weighting coefficient being representative of the probability that the pixel or superpixel associated with the first node belongs to foreground or background,
each second node is connected to each terminal node via a second weighted edge, a second weighting coefficient being associated with the second weighted edge, the second weighting coefficient being representative of the foreground probability associated with the 3D sample associated with the second node,
the first nodes are connected with each other via third weighted edges, a third weighting coefficient being associated with each third weighted edge, the third weighting coefficient being representative of the similarity between two nodes connected with the third weighted edge,
the second nodes are connected with the first nodes onto which they project fourth weighted edges, a fourth weighting coefficient being associated with each fourth weighted edge, the fourth weighting coefficient corresponding to a binary term ensuring projection consistency between a 3D sample and the pixels or superpixels of said n images onto which the 3D sample projects,
the cutting of the graph comprising the first weighted edges, second weighted edges, third weighted edges and fourth weighted edges having a minimal sum of weighting coefficients over the severed edges.

4. The method according to claim 2, wherein the graph comprises fifth weighted edges connecting at least a first node associated with a pixel or a superpixel of a first image of said n images with at least a first node associated with a pixel or a superpixel of a second image, the first image representing the scene according to a first point of view at a time t and the second image representing the scene according to the first point of view at a time t+1 following the time t.

5. The method according to claim 1, further comprising refining the foreground/background segmentation in each view.

6. The method according to claim 5, wherein said refining the foreground/background segmentation comprises soft classifying a pixel of a view into the foreground region or into the background region of said view according to a comparison result between a color information associated with said pixel and the first and second color models associated with said view and according to the probability of the 3D sample associated with said pixel.

7. The method according to claim 1, wherein the convergence criterion of said reiterating is met when the first and second colors models in each image do not vary during at least m consecutive iterations of the method, m being greater than 2.

8. The method according to claim 1, wherein the convergence criterion of said reiterating is met when the selected 3D samples having a foreground label do not vary during at least m consecutive iterations of the method, m being greater than 2.

9. The method according to claim 1, wherein the bounding volume is determined by intersecting the visual fields associated to said capturing devices.

10. The method according to claim 1, wherein said bounding volume is determined by user inputs.

11. The method according to claim 1, wherein the first and second color models for each image are color histograms.

12. The method according to claim 1, wherein the selected 3D samples are obtained by applying one of the following samplings on the 3D points within the bounding volume:
a regular 3D sampling according to predetermined grid,
a random sampling, and
an adaptive sampling.

13. The method according to claim 1, wherein the second color model of the background region each image is defined in each image in order to be consistent with the color model of the points outside of the bounding volume.

14. A module configured for segmenting a foreground region from a background region in a three-dimensional scene, wherein said scene is captured by n capturing devices disposed at several points of view and generating n images or views of the scene, with n≧2, the module comprising:
a memory configured to store said n images of the scene, program instructions and data necessary for the operation of the foreground segmentation module,
at least a processor configured for:
determining a volume in 3D space bounding said foreground region;
computing, for each image, initial estimates of a first color model associated to the foreground region within the projection of the bounding volume in the image, and a second color model associated to the background region within the projection of the bounding volume in the image;
selecting a plurality of 3D samples inside the bounding volume according to a predetermined law;
projecting the selected 3D samples in each image;
computing, in each image, the color probabilities that the colors associated to the projection of the selected 3D samples belong to the first and second color models,
computing, for each one of the selected 3D samples, a probability, called foreground probability, that it belongs to the foreground region in the n images and, for each image, a probability, called background probability, that it belongs to the background region of said image according to the color probabilities,
updating said first and second color models in each image according to the foreground and background probabilities associated to the 3D samples;
reiterating said computing and updating operations until the first and second color models of the foreground and background probabilities of the selected 3D samples meet a predetermined convergence criterion; and
refining the foreground/background segmentation in each view.

15. The module according to claim 14, wherein the at least a processor is further configured for:
constructing a graph comprising two terminal nodes, a foreground label being associated with one of the two terminal nodes and a background label being associated with the other one of the two terminal nodes, first nodes each associated with a pixel or a superpixel of said n images, second nodes each associated with a 3D sample of the selected 3D samples, the first and second nodes being connected to each of the two terminal nodes via first and second weighted edges, the first nodes being connected with each other via third weighted edges and the second nodes being connected with each other via fourth weighted edges,
cutting said graph according to the graph cut method in a first and in a second part, the first part of the graph comprising one of the two terminal nodes, at least a part of the first nodes and a at least a part of the second nodes and the second part of the graph comprising the other one of the two terminal nodes and the first and second nodes not comprised in the first part.
